(19) United States
(12) Patent Application Publication
(10) Pub. No.: US 2023/0266652 A1
(43) Pub. Date: Aug. 24, 2023

(54) LIGHT SOURCE DEVICE AND DISPLAY APPARATUS

(71) Applicants: Tomoya FUJII, Kanagawa (JP); Jun MASHIMO, Kanagawa (JP); Yuuto AKIBA, Kanagawa (JP)

(72) Inventors: Tomoya FUJII, Kanagawa (JP); Jun MASHIMO, Kanagawa (JP); Yuuto AKIBA, Kanagawa (JP)

(21) Appl. No.: 18/109,282

(22) Filed: Feb. 14, 2023

(30) Foreign Application Priority Data
Feb. 24, 2022 (JP) 2022-026927
May 30, 2022 (JP) 2022-087945

(51) Int. Cl. G03B 21/20; H04N 9/31

(52) U.S. Cl. CPC G03B 21/204; H04N 9/3161

(57) ABSTRACT

A light source device includes: a light emitter including a light emitting surface to emit first light having a first wavelength in a light emitting direction; an optical system to condense the first light having the first wavelength at a light condensed position; and a wavelength converter including a wavelength conversion region to convert the first light having the first wavelength to second light having a second wavelength. A center axis of the wavelength converter is parallel to the light emitting surface, the light emitter is at a position adjacent to one end of the wavelength converter in the light emitting direction in a plane orthogonal to the center axis of the wavelength converter, and the light condensed position of the optical system is closer to the light emitter than another end of the wavelength converter opposite to the one end in the light emitting direction in the plane.

### CROSS-REFERENCE TO RELATED APPLICATIONS

This patent application is based on and claims priority pursuant to 35 U.S.C. § 119(a) to Japanese Patent Application No. 2022-026927, filed on Feb. 24, 2022, in the Japan Patent Office, and Japanese Patent Application No. 2022-087945, filed on May 30, 2022, in the Japan Patent Office, the entire disclosure of which is hereby incorporated by reference herein.

### BACKGROUND

### Technical Field

The present disclosure relates to a light source device and a display apparatus.

### Related Art

A light source device is used in a display apparatus. Examples of the display apparatus include a projector for displaying an image onto a screen.

For example, in a light source device, a configuration including an optical system that condenses light having a first wavelength emitted from a light emitter and a wavelength converter that receives the light condensed by the optical system and emits light having a second wavelength different from the first wavelength is disclosed.

### SUMMARY

A light source device includes: a light emitter including a light emitting surface to emit first light having a first wavelength in a light emitting direction; an optical system to condense the first light having the first wavelength at a light condensed position; and a wavelength converter including a wavelength conversion region to convert the first light having the first wavelength to second light having a second wavelength. A center axis of the wavelength converter is parallel to the light emitting surface, the light emitter is at a position adjacent to one end of the wavelength converter in the light emitting direction in a plane orthogonal to the center axis of the wavelength converter, and the light condensed position of the optical system is closer to the light emitter than another end of the wavelength converter opposite to the one end in the light emitting direction in the plane.

Further, an embodiment of the present disclosure provides a display apparatus a display apparatus includes: a spatial light modulator including multiple pixels to turn on and off the light emitted from the light source device described above for each of the multiple pixels to generate an image; and a projection optical system to project the image generated by the spatial light modulator.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram of an internal configuration of a light source device according to a first embodiment:

FIG. 2 is a diagram of the light source device as viewed from the arrow A in FIG. 1;

FIG. 3 is a diagram of the light source device as viewed from the arrow B in FIG. 1 as a first example;

FIG. 4 is a diagram of the light source device as viewed from the arrow B in FIG. 1 as a second example;

FIG. 5 is a diagram of the light source device as viewed from the arrow B in FIG. 1 as a third example;

FIG. 6 is a diagram of an internal configuration of a display apparatus according to a second embodiment; and

FIG. 7 is a diagram of an internal configuration of the light source device according to a third embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed fir the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a” “an,” and “the” are intended to include the plural forms as well, unless the context clearly indicates otherwise.

According to the present embodiments, the light source device is reduced in size.

Embodiments of the present disclosure are described with reference to the drawings. In the drawings, the same components are denoted by the same reference number, and redundant description thereof will be appropriately omitted.

The embodiments described below are examples of a light source device and a display apparatus for embodying the technical idea of the present invention, and the present invention is not limited to the embodiments described below. Unless otherwise specified, shapes of components, relative arrangements thereof, and values of parameters described below are not intended to limit the scope of the present invention but are intended to exemplify the scope of the present invention. The relative positions or the size of the elements illustrated in the drawings may be exaggerated for purpose of clear illustration.

### First Embodiment

### Example of Light Source Device

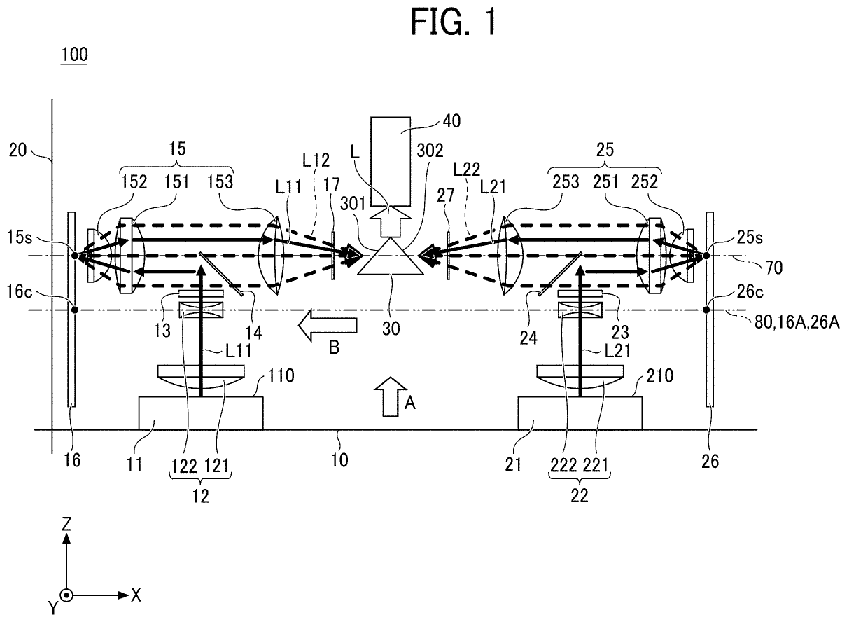

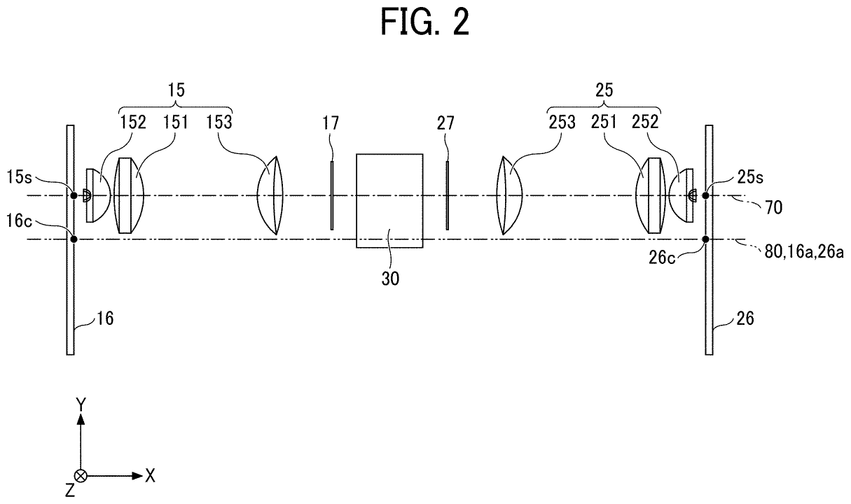

An example of a configuration of a light source device 100 according to the first embodiment will be described with reference to FIGS. 1 and 2. FIG. 1 is a diagram of the internal configuration of the light source device 100. FIG. 2 is a diagram of the light source device as viewed from the arrow A in FIG. 1. The light source device 100 is a device to emit light L. The light L emitted from the light source device 100 is used, for example, in a display apparatus such as a projector for displaying an image onto a screen.

As illustrated in FIG. 1, the light source device 100 includes a first light emitter 11, a first relay lens 12, a first lens array 13, a first dichroic mirror 14, a first optical system 15, a first wavelength converter 16, and a first light diffuser 17. In addition, the light source device 100 includes a second light emitter 21, a second relay lens 22, a second lens array 23, a second dichroic mirror 24, a second optical system 25, a second wavelength converter 26, and a second light diffuser 27. The light source device 100 further includes a light combiner 30 and a light homogenizer 40.

The first light emitter 11 including a first light emitting surface 110 is an example of a light emitter and is disposed on a mounting surface 10. The vertical plane 20 represents a plane orthogonal to the mounting surface 10. The mounting surface 10 is disposed on the positive side in the Z-axis in a mounting substrate that mounts the first light emitter 11. The first light emitter 11 includes multiple semiconductor lasers arranged in two dimensions and emits the first laser L11 emitted from each of the multiple semiconductor lasers to the first relay lens 12. The first laser light L11 has a first wavelength corresponding to blue light or ultraviolet light and excites a first wavelength conversion region included in the first wavelength converter 16.

The first laser light L11 emitted from the first light emitter 11 is substantially collimated by the lens 121 and the lens 122 in the first relay lens 12, is transmitted through the first lens array 13, and enters the first dichroic mirror 14. The first dichroic mirror 14 is a wavelength-selective mirror that reflects the first laser light L11 of the first wavelength and transmits light other than that of the first wavelength.

The first laser light L11 reflected by the first dichroic mirror 14 reaches the first optical system 15. The first optical system 15 is an example of an optical system to condense the first laser light L11 emitted from the first light emitter 11.

The first optical system 15 includes the lens 151, the lens 152, and the lens 153. The first optical system 15 condenses the first laser light L11 reflected from the first dichroic mirror 14 on the first wavelength converter 16 by the lens 151 and the lens 152. The first light condensed position 15s represents the light condensed position of the first laser light L11 on the first wavelength converter 16 by the first optical system 15.

The first wavelength converter 16 is an example of a wavelength converter including the wavelength conversion region that receives the first laser light L11 condensed by the first optical system 15 and emits light having a second wavelength different from the first wavelength. The first wavelength converter 16 is provided so that the center axis 16A of the first wavelength converter 16 is along the mounting surface 10 (i.e., the center axis 16A is parallel to the mounting surface 10). The first wavelength converter 16 includes the first wavelength conversion region and a first reflection region. The first wavelength converter 16 emits the first fluorescent light L12 from the first wavelength conversion region and emits the first laser light L11 by reflecting by the first reflection region.

In the first optical system 15, the lens 152 and the lens 151 guide the first laser light L11 and the first fluorescent light L12 emitted from the first wavelength converter 16 to the lens 153. The lens 153 condenses the first laser light L11 and first fluorescent L12 guided through the first optical system 15 on the first reflecting surface 301 of the light combiner 30 through the first light diffuser 17. The first light diffuser 17 includes a light diffusing surface and diffuses the first laser light L11 and the first fluorescent light L12 that pass through the first light diffuser 17 itself.

The second light emitter 21 including the second light emitting surface 210 is an example of a light emitter and is mounted on the mounting surface 10. The second light emitter 21 includes multiple semiconductor lasers arranged in two dimensions and emits the second laser light L21 from each of multiple semiconductor lasers to a second relay lens 22. The second laser light L21 has a first wavelength corresponding to blue light or ultraviolet light and excites a second wavelength conversion region included in the second wavelength converter 26.

The second laser light L21 emitted from the second light emitter 21 is substantially collimated by the lens 221 and the lens 222 in the second relay lens 22, passes through the second lens array 23, and strikes on the second dichroic mirror 24. The second dichroic mirror 24 is a wavelength-selective mirror that reflects the second laser light L21 of the first wavelength and transmits light other than that of the first wavelength.

The second laser light 121 reflected by the second dichroic mirror 24 reaches the second optical system 25. The second optical system 25 is an example of an optical system to condense the second laser light L21 emitted from the second light emitter 21.

The second optical system 25 includes a lens 251, a lens 252, and a lens 253. The second optical system 25 condenses the second laser light L21 reflected from the second dichroic mirror 24 on the second wavelength converter 26 by the lens 251 and the lens 252. The second light condensed position 25s represents a position at which the second optical system 25 condenses the second laser light L21 on the second wavelength converter 26.

The second wavelength converter 26 is an example of a wavelength converter including a wavelength conversion region that receives the second laser light L21 emitted from the second light emitter 21 and emits light having a second wavelength different from the first wavelength. The second wavelength converter 26 is provided so that the center axis 26A of the second wavelength converter 26 is along, or parallel to the mounting surface 10 (i.e., the center axis 26A is parallel to the mounting surface 10). The second wavelength converter 26 includes a second wavelength conversion region and a second reflection region. The second wavelength converter 26 emits the second fluorescent light L22 from the second wavelength conversion region and emits the second laser light L21 by reflecting by the second reflection region.

In the second optical system 25, the second laser light L21 and the second fluorescent light L22 emitted from the second wavelength converter 26 are guided to the lens 253 by the lens 252 and the lens 251. The lens 253 condenses the second laser light L21 and second fluorescent light L22 guided through the second optical system 25 on the second reflecting surface 302 of the light combiner 30 through the second light diffuser 27. The second light diffuser 27 includes a light diffusing surface and diffuses the second laser light L21 and the second fluorescent light L22 that pass through the second light diffuser 27 itself.

The light combiner 30 reflects the light diffused by the first light diffuser 17 by the first reflecting surface 301, and reflects the light diffused by the second light diffuser 27 by a second reflecting surface 302. Thus, the light combiner 30 emits the light L obtained by combining the first laser light L11, the first fluorescent light L12, the second laser light L21, and the second fluorescent light L22 to the light homogenizer 40. The light combiner 30 is, for example, a right-angle prism, but is not limited to the right-angle prism and may be any member as long as it can combine the first laser light L11, the first fluorescent light L12, the second laser light L21, and the second fluorescent light L22.

The light homogenizer 40 homogenizes (mixes) the light emitted from the light combiner 30 to uniform (homogenize) the light (i.e., the intensity distribution of the light). As the light homogenizer 40, for example, a light tunnel in which four mirrors are combined, a rod integrator, or a fly-eye lens is used.

The light source device 100 emits the light L homogenized (uniformized) by the light homogenizer 40.

In the present embodiment, the first optical system 15 and the second optical system 25 may have the same configuration. The first wavelength converter 16 and the second wavelength converter 26 may have the same configuration.

As illustrated in FIGS. 1 and 2, the line 70 passing through the first light condensed position 15s and the second light condensed position 25s is along the line 80 passing through the center axis 16c of the first wavelength converter 16 and the second center axis 26c of the second wavelength converter 26. Herein, the line 70 and the line 80 are parallel to each other. In other words, the line 70 and the line 80 are substantially parallel to each other. Herein, the term “substantially” in substantially parallel includes a deviation to a degree generally recognized as an error. The error is allowable. In the present embodiment, for example, a deviation from parallelism is ±5 degrees or less. In other words, there is a tolerance of ±5 degrees or less. In FIG. 1, since the line 80, the center axis 16A, and the center axis 26A are coaxial, the respective reference numerals are used together.

In the light source device 100 according to the embodiments, the optical system includes: a first optical system 15 to condense the first light having the first wavelength; and a second optical system 25 to condense a third light having a third wavelength. The wavelength converter includes: a first wavelength converter 16 to convert the first light to the second light; and a second wavelength converter 26 to convert the third light to fourth light having a fourth wavelength different from the third wavelength, and a first straight line extending a first center axis (e.g., the center axis 16A) of the first wavelength converter 16 is parallel to a second straight line extending a second center axis (e.g., the center axis 26A) of the second wavelength converter 26.

In the light source device 100 according to the embodiments, the light emitter includes: a first light emitter 11 to emit first light having a first wavelength; and a second light emitter 21 to emit third light having a third wavelength. The optical system includes: a first optical system 15 to condense the first light emitted from the first light emitter at a first light condensed position 15s; and a second optical system 25 to condense the third light emitted from the second light emitter at a second light condensed position 25s. The wavelength converter includes: a first wavelength converter 16 to convert the first light to the second light; and a second wavelength converter 26 to convert the third light to fourth light having a fourth wavelength different from the third wavelength. An optical axis (e.g., the line 70) passing through the first light condensed position 15s and the second light condensed position 25s is parallel to a line 80 passing through a first center axis 15c of the first wavelength converter 16 and a second center axis 26c of the second wavelength converter 26.

The light source device 100 may further include a light emitter other than the first light emitter 11 and the second light emitter 21. Each of the first light emitter 11 and the second light emitter 21 is not limited to multiple semiconductor lasers, and may include one semiconductor laser or one or more light emitters to emit incoherent light such as a light emitting diode (LED). The light source device 100 may not include the first relay lens 12, the first lens array 13, the first light diffuser 17, the second relay lens 22, the second lens array 23, and the second light diffuser 27.

### Example of Configuration Around First Wavelength Converter

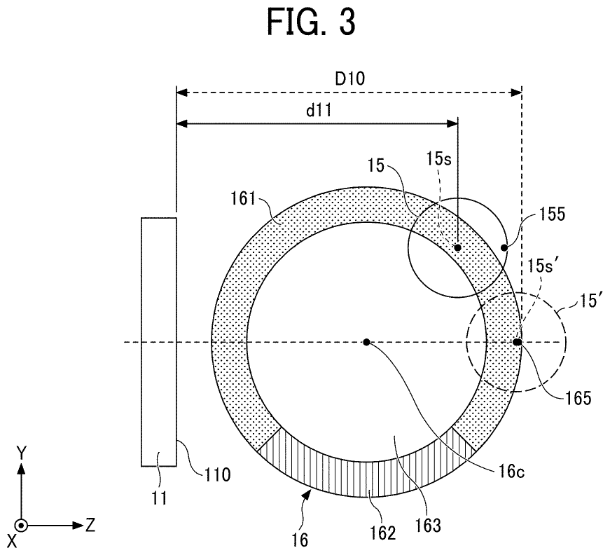

An example of the configuration around the first wavelength converter 16 will be described. FIG. 3 is a diagram of the light source device as viewed from the arrow B in FIG. 1 as the first example.

As illustrated in FIG. 3, the first wavelength converter 16 includes a first wavelength conversion region 161 and a first reflection region 162 on the first rotating substrate 163. The first rotating substrate 163 has a substantially circular shape in plain view as viewed from the normal direction thereof, and is rotationally driven around the center axis 16A (FIG. 1) of the first wavelength converter 16. The first wavelength conversion region 161 and the first reflection region 162 are provided so as to form a part of an annular region on the first wavelength converter 16 in plain view.

The first wavelength conversion region 161 is a phosphor (fluorescent material) region to emit the first fluorescent light L12 excited by the first laser light L11. The wavelength of the first fluorescent light L12 corresponds to the second wavelength. The first reflection region 162 reflects the first laser light L11 condensed from the first optical system 15 and emits the first wavelength of the first laser light L11 received from the first optical system 15 without conversion.

The first optical system 15 is provided so that the first laser light L11 is condensed on the first wavelength conversion region 161 and the first reflection region 162 of the first wavelength converter 16. By rotating the first wavelength converter 16 around the center axis 16A, the first wavelength conversion region 161 and the first reflection region 162 are alternately exchanged, and the first laser light L11 and the first fluorescent L12 are emitted in a time division manner.

The first wavelength converter 16 may further include a phosphor (fluorescent material) region to emit fluorescent light having a wavelength other than the first wavelength and the second wavelength. The first wavelength converter 16 is not limited to being rotationally driven, but may be driven in translation in a direction intersecting with the center axis 16A, or may not be driven. The shape of the first wavelength converter 16 in plain view is not limited to a substantially circular shape, but may be a substantially elliptical shape, or a substantially polygonal shape.

In the light source device 100 according to the first example, when the first wavelength converter 16 and the first light emitter 11 are viewed from a direction along the center axis of the first wavelength converter 16 (i.e., as viewed from a direction indicated by arrow B in FIG. 1), the first optical system 15 condenses the first laser light L11 at a position (i.e., the first light condensed position 15s) closer than an edge portion 165 of the first wavelength converter 16 to the first light emitter 11. Herein, the edge portion 165 of the first wavelength convert 16 is at one end of the first wavelength converter 16, and the other edge portion of the first wavelength converter 16 is at the other end of the first wavelength converter 16 and closer to the first light emitter 11 than the edge portion 165 is.

A light source device 100 includes: a light emitter (e.g., the first light emitter 11) including a light emitting surface (e.g., the first light emitting surface 110) to emit first light having a first wavelength in a light emitting direction (e.g., the Z-direction in FIG. 1); an optical system (e.g., the first optical system 15) to condense the first light having the first wavelength at a light condensed position (e.g., the first light condensed position 15s); and a wavelength converter (e.g., the first wavelength converter 16) including a wavelength conversion region (e.g., the first wavelength conversion region 161) to convert the first light having the first wavelength to second light having a second wavelength different from the first wavelength. A center axis (e.g., the center axis 16A) of the wavelength converter is parallel to the light emitting surface, the light emitter is at a position adjacent to one end of the wavelength converter in the light emitting direction in a plane orthogonal to the center axis of the wavelength converter, and the light condensed position of the optical system is closer to the light emitter than another end (e.g., the edge portion 165) of the wavelength converter opposite to the one end in the light emitting direction in the plane.

In the light source device 100 according to the embodiments, further includes a light combiner 30, and the optical system includes: a first optical system 15 to condense the first light having the first wavelength at a first light condensed position 15s; and a second optical system 25 to condense a third light having a third wavelength at a second light condensed position 25s. The wavelength converter includes: a first wavelength converter 16 to convert the first light to the second light; and a second wavelength converter 26 to convert the third light to fourth light having a fourth wavelength different from the third wavelength, the light combiner 30 to combine the first light the second light, the third light, and the fourth light at a combining position to emit combined light, the first light condensed position 15s, the second light condensed position 25s, and the combining defines a first plane, a first center axis 16A of the first wavelength converter 16 and a second center axis (e.g., the center axis 26A) of the second wavelength converter 26 defines a second plane, and the first plane is parallel to and different from the second plane.

In FIG. 3, the edge portion 155 represents an edge portion of the first optical system 15 on the other side of another edge portion adjacent to the first light emitter 11. The first optical system 15′ indicated by a broken line is the case where the first optical system is arranged so that the first light condensed position 15s′ is consistent with an edge portion 165 of the first wavelength converter 16 on the opposite side of the first light emitter 11. The distance d11 represents the distance between the first light condensed position 15s and the first light emitting surface 110. The distance D10 represents the distance between the first light condensed position 15s′ and the first light emitting surface 110. The distance d11 is shorter than the distance D10.

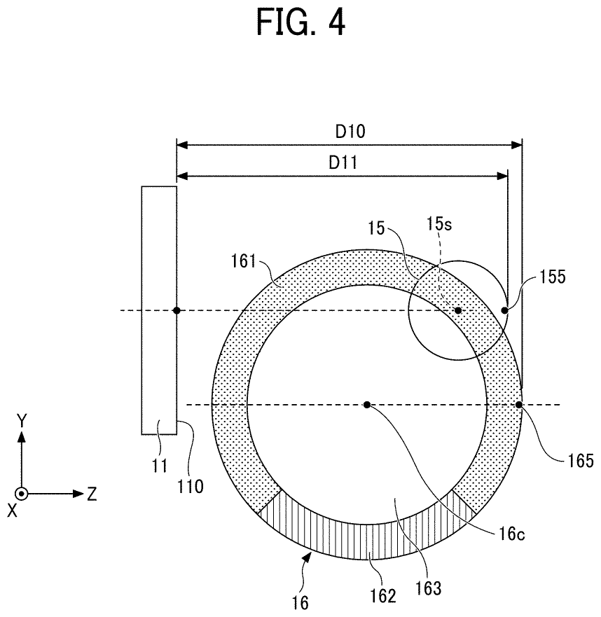

FIG. 4 is a diagram of the light source device as viewed from the direction indicated by arrow B in FIG. 1, according to the second example. As illustrated in FIG. 4, in the light source device 100 according to the second example, when the first wavelength converter 16 and the first light emitter 11 are viewed from a direction along the center axis 16A of the first wavelength converter 16 (i.e., as viewed from the arrow B in FIG. 1), the edge portion 155 of the first optical system 15 is closer than the edge portion 165 of the first wavelength converter 16 to the first light emitter 11. Herein, the edge portion 165 of the first wavelength converter 16 is disposed on the opposite side from another edge portion adjacent to the first light emitter 11. The distance D11 represents the distance between the edge portion 155 of the first optical system 15 and the first light emitting surface 110. The distance D11 is shorter than the distance D10.

In the light source device 100 according to the embodiments, an edge portion (e.g., the edge portion 155) of the optical system (e.g., the first optical system 15) is: closer to another end (e.g., the edge portion 165) of the wavelength converter than the light condensed position; and closer to the light emitter than another end of the wavelength converter in the light emitting direction in the plane.

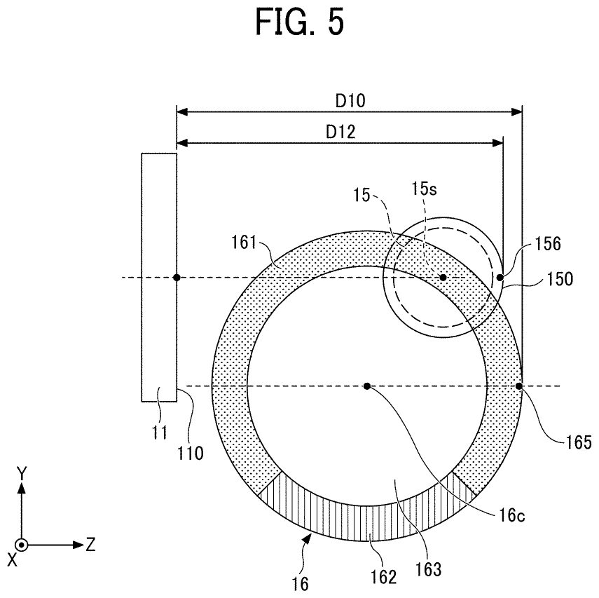

FIG. 5 is a diagram of the light source device as viewed from the arrow B in FIG. 1, according to the third example. As illustrated in FIG. 5, the light source device 100 according to the third example includes a holder 150 holding the first optical system 15. In the light source device 100 according to the third example, when the first wavelength converter 16 and the first light emitter 11 are viewed from a direction along the center axis 16A of the first wavelength converter 16 (i.e., as viewed from the arrow B in FIG. 1), an edge portion 156 of the holder 150 is closer than the edge portion 165 of the first wavelength converter 16 to the first light emitter 11. Herein, the edge portion 165 of the first wavelength converter 16 is disposed on the opposite side from another edge portion adjacent to the first light emitter 11. The distance D12 represents the distance between the edge portion 156 of the holder 150 and the first light emitting surface 110. The distance D12 is shorter than the distance D10.

In the light source device 100 according to the embodiments, further includes: a holder (e.g., the holder 150) holding the optical system (e.g., the first optical system 15), and an edge portion (e.g., the edge portion 156) of the holder is: closer to another end (e.g., the edge portion 165) of the wavelength converter than the light condensed position; and closer to the light emitter than another end of the wavelength converter in the light emitting direction in the plane.

Operation and Effect of Light Source Device

As described above, the light source device 100 includes the first light emitter 11 (light emitter) of the first light emitting surface 110, the first wavelength converter 16 (wavelength converter), and the first optical system 15 (optical system). The first wavelength converter 16 is arranged so that the center axis 16A of the first wavelength converter 16 is along the first light emitting surface 110. In other words, the center axis 16A is parallel to the first light emitting surface 110. When the first wavelength converter 16 and the first light emitter 11 are viewed from a direction along the center axis 16A of the first wavelength converter 16 (i.e., as viewed from the arrow B in FIG. 1), the first optical system 15 condenses the first laser light L11 at a position closer than the edge portion 165 of the first wavelength converter 16 to the first light emitter 11. Herein, the edge portion 165 of the first wavelength converter is disposed on the opposite side from another edge portion adjacent to the first light emitter 11. According to the configuration described above, since the edge portion 155 of the first optical system 15 is disposed on a position closer than the edge portion 165, on which the first optical system 15 condenses the first laser light L11, of the first wavelength converter 16, the light source device 100 is reduced in size accordingly.

Further, when the first wavelength converter 16 and the first light emitter 11 are viewed from a direction along the center axis 16A of the first wavelength converter 16, the light source device 100 may be configured so that the edge portion 155 of the first optical system 15 is disposed on a position closer than the edge portion 165 of the first wavelength converter 16 to the first light emitter 11. According to the configuration described above, the light source device 100 is reduced in size more than the case where the edge portion 155 of the first optical system 15 is disposed at a position further than the edge portion 165 of the first wavelength converter 16 to the first light emitter 11. Herein, the edge portion 155 of the first optical system 15 is disposed on the opposite side from another edge portion adjacent to the first light emitter 11.

The light source device 100 may have a holder 150. In the case where the first wavelength converter 16 and the first light emitter 11 are viewed from the direction along the center axis 16A of the first wavelength converter 16, the edge portion 156 of the holder 150 may be disposed at a position closer than the edge portion 165 of the first wavelength converter 16 to the first light emitter 11. According to the configuration described above, the light source device 100 is reduced in size as compared with the case where the edge portion 156 of the holder 150 is disposed on a position closer than the edge portion 165 of the first wavelength converter 16 to the first light emitter 11. Herein, the edge portion 156 of the holder 150 is disposed on the opposite side from another edge portion adjacent to the first light emitter 11.

The light source device 100 includes a first light emitter 11, a second light emitter 21, a first wavelength converter 16, a second wavelength converter 26, a first optical system 15, and a second optical system 25. The first optical system 15 condenses the first laser light L11, and the second optical system 25 condenses the second laser light L21. A line 70 passing through the first light condensed position 15s by the first optical system 15 and the second light condensed position 25s by the second optical system 25 is along a line 80 passing through the center axis 16c of the first wavelength converter 16 and the second center axis 26c of the second wavelength converter 26. According to the configuration, the light source device 100 is reduced in size as compared with the case where the lines 70 and 80 are tilted.

Further, the light source device 100 excites the first wavelength conversion region 161 of the first wavelength converter 16 by the first laser light L11 emitted from the first light emitter 11, and excites the second wavelength conversion region 261 of the second wavelength converter 26 by the second laser light L21 emitted from the second light emitter 21. Thus, as compared with the case where one wavelength conversion region is excited by both of the first light emitter 11 and the second light emitter 21, heat generation in the wavelength conversion region is reduced, and the wavelength conversion efficiency by the wavelength converter is less likely to be reduced. As a result, the light source device 100 that emits the light L with higher brightness is provided.

The light source device 100 may not include the second light emitter 21, the second relay lens 22, the second lens array 23, the second dichroic mirror 24, the second optical system 25, the second wavelength converter 26, and the second light diffuser 27. The effect of reducing the size of the light source device 100 can be obtained even when these parts, elements, or members described above are not included.

### Second Embodiment

A display apparatus 200 according to a second embodiment will be described. In the second embodiment, the same components as those in the first embodiment are denoted by the same reference numerals, and redundant description thereof is appropriately omitted. This point is also applied to other embodiments described below.

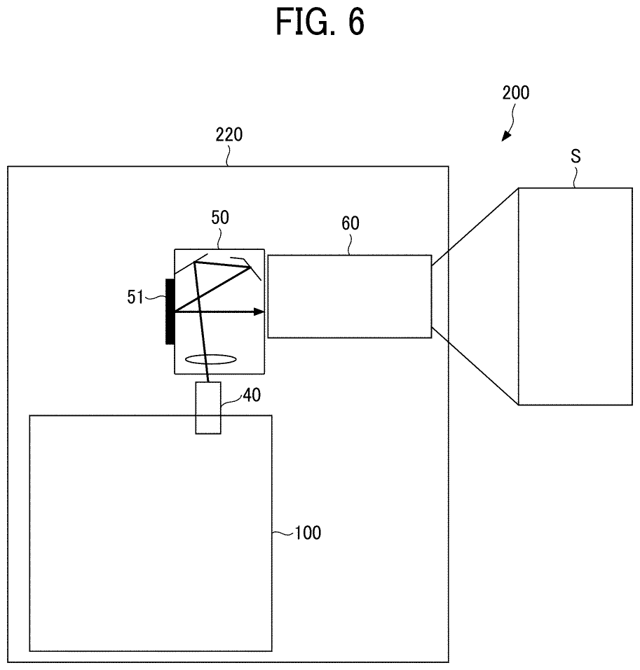

FIG. 6 is a diagram of an internal configuration of a display apparatus according to a second embodiment. The display apparatus 200 is, for example, a projector that projects an image onto the screen S to display the image. The display apparatus 200 includes a housing 220, a light source device 100, an illumination optical system 50, a spatial light modulator 51, and a projection optical system 60.

The housing 220 houses the light source device 100, the illumination optical system 50, the spatial light modulator 51, and the projection optical system 60.

For example, the light source device 100 emits light having wavelengths corresponding to respective colors of red (R), green (G), and blue (B).

The illumination optical system 50 substantially uniformly illuminates the spatial light modulator 51 with the light L emitted from the light source device 100. The illumination optical system 50 includes, for example, one or more lenses and one or more reflecting surfaces.

The spatial light modulator 51 includes multiple pixels, and generates an image by turning on or off the light L emitted from the light source device 100 at each pixel and passed through the illumination optical system 50. The spatial light modulator 51 includes, for example, a light valve such as a digital micromirror device (DMD), a transmissive liquid crystal panel, or a reflective liquid crystal panel.

The projection optical system 60 enlarges the image generated by the spatial light modulator 51 and projects the enlarged image onto the screen S. The projection optical system 60 includes, for example, one or more lenses.

Since the display apparatus 200 includes the light source device 100, the display apparatus 200 is less likely to become larger in size.

A display apparatus 200 includes: a spatial light modulator 51 including multiple pixels to turn on and off the light emitted from the light source device 100 according to the embodiments for each of the multiple pixels to generate an image; and a projection optical system 60 to project the image generated by the spatial light modulator 51.

### Third Embodiment

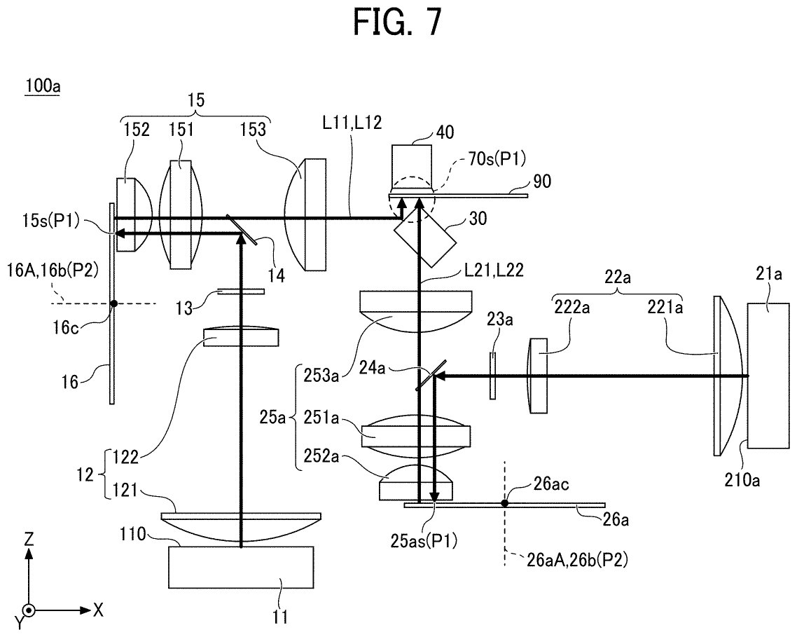

FIG. 7 is a diagram of an internal configuration of the light source device according to the third embodiment. The light source device 100a includes a second light emitter 21a, a second relay lens 22a, a second lens array 23a, a second dichroic mirror 24a, a second optical system 25a, a second wavelength converter 26a, and a color wheel 90. The second relay lens 22a includes a lens 221a and a lens 222a. The second optical system 25a includes a lens 251a, a lens 252a, and a lens 253a.

The second light emitter 21a includes the same configuration and functions as the second light emitter 21 described above, the second relay lens 22a has the same configuration as the second relay lens 22 described above, and the second lens array 23a has the same configuration and functions as the second lens array 23a described above, and the direction in which the second light emitter 21a is disposed is rotated by 90 degrees. The second dichroic mirror 24a has the same configuration and function as those of the second dichroic mirror 24 described above, the second optical system 25a has the same configuration as that of the second optical system 25 described above, and the second wavelength converter 26a has the same configuration and function as those of the second wavelength converter 26a described above, and the direction in which the second dichroic mirror 24a is disposed is rotated by 90 degrees.

A first light emitting surface 110 of the first light emitter 11 is disposed substantially parallel to the center axis 16A of the first wavelength converter 16. Herein, the term “substantially parallel” includes a deviation from the parallel state to a degree generally recognized as an error. The error is allowable. Specifically, “substantially parallel” includes a deviation from the parallel state of ±1 degree or less. In other words, there is a tolerance of ±1 degree or less.

The light emitted from the first light emitter 11 passes through the first relay lens 12, the first lens array 13, the first dichroic mirror 14, and the first optical system 15 in this order, and is condensed on the first light condensed position 15s of the first wavelength converter 16 (i.e., condensed light). The first wavelength converter 16 emits first laser light L11 that reflects the condensed light and the first fluorescent L12 wavelength-converted from the condensed light. The first laser light L11 and the first fluorescent light L12 (i.e., light emitted from the first wavelength converter 16) reach the light combiner 30 through the first optical system 15, are reflected by the light combiner 30, and reach the color wheel 90.

The second light emitting surface 210a of the second light emitter 21a is disposed substantially parallel to the center axis 26aA of the second wavelength converter 26a. A straight line including the center axis 26aA (i.e., the light extending along the center axis 26aA) of the second wavelength converter 26a intersects with a straight line including the center axis 16A of the first wavelength converter 16. In the present embodiment, the straight line including the center axis 26aA is substantially orthogonal to the straight line including the center axis 16A. Herein, “substantially orthogonal” includes a deviation from the orthogonal state to a degree generally recognized as an error. The error is allowable. Specifically, “substantially orthogonal” includes a deviation from the orthogonal state of ±1 degree or less. In other words, there is a tolerance of +1 degree or less.

In the light source device 100 according to the embodiments, the optical system includes: a first optical system 15 to condense the first light having the first wavelength; and a second optical system 25 to condense a third light having a third wavelength, the wavelength converter includes: a first wavelength converter 16 to convert the first light to the second light; and a second wavelength converter 26 to convert the third light to fourth light having a fourth wavelength different from the third wavelength. A first straight line extending a first center axis (e.g., the center axis 16A) of the first wavelength converter 16 intersects with a second straight line extending a second center axis (e.g., the center axis 26A) of the second wavelength converter 26.

The light emitted from the second light emitter 21a passes through the second relay lens 22a, the second lens array 23a, the second dichroic mirror 24a, and the second optical system 25a in this order, and is condensed at the second light condensed position 25as of the second wavelength converter 26a. The second wavelength converter 26a emits the second laser light L21 that reflects the condensed light and the second fluorescent light L22 that is wavelength-converted from the condensed light. After passing through the second optical system 25a, the second laser light L21 and the second fluorescent light L22 (i.e., light emitted from the second wavelength converter 26a) pass through the outside region of the light combiner 30 and reach the color wheel 90. Thus, the light emitted from the second wavelength converter 26a reaches the color wheel 90 without passing through the light combiner 30.

The light emitted from the first wavelength converter 16 and the light emitted from the second wavelength converter 26a are combined (i.e., combined light) at the combining position 70s. The combined light enters the light homogenizer 40.

The combining position 70s is a position in which the first laser light L11 and the second laser light L21 are closest to each other. In the case where the first laser light L11 and the second laser light L21 pass through substantially the same position (i.e., the substantially same passing position), the substantially same passing position corresponds to the combining position 70s. Alternatively, the combining position 70s is a position in which the first fluorescent light L12 and the second fluorescent light L22 are closest to each other. In the case where the first fluorescent light L12 and the second fluorescent light L22 pass through substantially the same position (i.e., the substantially same passing position), the substantially same passing position corresponds to the combining position 70s.

Exactly, all light (illumination light) emitted from the light source device 100a are combined at the incident position to the light homogenizer 40. Thus, the position at which the first laser light L11 and the second laser light L21 are combined or the position at which the first fluorescent light L12 and the second fluorescent light L22 are combined may be the center of the entrance (i.e., aperture) of the light homogenizer 40.

Since the combining position 70s is uniquely determined, a first plane P1 including three points of the combining position 70s, the first light condensed position 15s by the first optical system 15, and the second light condensed position 25as by the second optical system 25a are defined. In FIG. 7, a plane parallel to the XZ-plane corresponds to the first plane P1.

In the present embodiment, both the center axis 16c of the first wavelength converter and the center 26ac of the second wavelength converter 26a are disposed in either one of the spaces bisected by the first plane P1.

In the present embodiment, when a second plane P2 including both the center axis 16A of the first wavelength converter 16 and the center axis 26aA of the second wavelength converter 26a is defined, the first plane P1 is substantially parallel to the second plane P2. In FIG. 7, a plane parallel to the XZ-plane corresponds to the second plane P2.

In the present embodiment, when the first wavelength converter 16 and the first light emitter 11 are viewed from a direction along the center axis 16A of the first wavelength converter 16, the first optical system 15 condenses the first laser light L11 on a position closer than the edge portion of the first wavelength converter 16 to the first light emitter 11. Herein, the edge portion of the first wavelength converter 16 is disposed on the opposite side from another edge portion adjacent to the first light emitter 11. Thus, since the first optical system 15 is reduced in size as compared with the case where the edge portion of the first optical system 15 is disposed on a position closer than the edge portion of the first wavelength converter 16 to the first light emitter 11, the light source device 100a is entirely reduced in size. Herein, the edge portion of the first optical system 15 is disposed on the opposite side from another edge portion adjacent to the first light emitter 11.

Further, when the second wavelength converter 26a and the second light emitter 21a are viewed from a direction along the center axis 26aA of the second wavelength converter 26a, the second optical system 25a condenses the second laser light L21 on a position closer than the edge portion of the second wavelength converter 26a to the second light emitter 21a. Herein, the edge portion of the second wavelength converter 26a is disposed on the opposite side from another edge portion adjacent to the second light emitter 21a. Thus, since the second optical system 25 is reduced in size as compared with the case where the edge portion of the second optical system 25 is disposed on a position closer than the edge portion of the second wavelength converter 26 to the second light emitter 21, the light source device 100a is entirely reduced in size. Herein, the edge portion of the second optical system 25 is disposed on the opposite side from another edge portion adjacent to the second light emitter 21.

Even if the first light emitting surface 110 of the first light emitter 11 is arranged substantially parallel to the Z-axis, the same effect as described above is obtained. Even if the second light emitting surface 210a of the second light emitter 21a is arranged in parallel to the X-axis, the same effect as described above is obtained.

Although preferred embodiments of the present invention have been described in detail above, the present invention is not limited to these embodiments, and various modifications or changes are made within the scope of the present invention described in the claims below.

The light source device 100 is not limited to a display device, and can be used as a device that emits light source light in various optical devices.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Aspects of the present invention are as follows, for example.

In a first aspect, a light source device includes: a light emitter including a light emitting surface to emit first light having a first wavelength in a light emitting direction; an optical system to condense the first light having the first wavelength at a light condensed position; and a wavelength converter including a wavelength conversion region to convert the first light having the first wavelength to second light having a second wavelength different from the first wavelength. A center axis of the wavelength converter is parallel to the light emitting surface, the light emitter is at a position adjacent to one end of the wavelength converter in the light emitting direction in a plane orthogonal to the center axis of the wavelength converter, and the light condensed position of the optical system is closer to the light emitter than another end of the wavelength converter opposite to the one end in the light emitting direction in the plane.

In a second aspect, in the light source device according to the first aspect, an edge portion of the optical system is: closer to another end of the wavelength converter than the light condensed position; and closer to the light emitter than another end of the wavelength converter in the light emitting direction in the plane.

In a third aspect, the light source device according to the first aspect or the second aspect, further includes: a holder holding the optical system, and an edge portion of the holder is: closer to another end of the wavelength converter than the light condensed position; and closer to the light emitter than another end of the wavelength converter in the light emitting direction in the plane.

In a fourth aspect, the light source device according to the first aspect or the second aspect, further includes a light combiner. The optical system includes: a first optical system to condense the first light having the first wavelength at a first light condensed position; and a second optical system to condense a third light having a third wavelength at a second light condensed position. The wavelength convener includes: a first wavelength convener to convert the first light to the second light; and a second wavelength converter to convert the third light to fourth light having a fourth wavelength different from the third wavelength, the light combiner to combine the first light, the second light, the third light, and the fourth light at a combining position to emit combined light, the first light condensed position, the second light condensed position, and the combining defines a first plane, a first center axis of the first wavelength converter and a second center axis of the second wavelength converter defines a second plane, and the first plane is parallel to and different from the second plane.

In the fifth aspect, in the light source device according to the first aspect, the optical system includes: a first optical system to condense the first light having the first wavelength; and a second optical system to condense a third light having a third wavelength, the wavelength converter includes: a first wavelength converter to convert the first light to the second light; and a second wavelength converter to convert the third light to fourth light having a fourth wavelength different from the third wavelength. A first straight line extending a first center axis of the first wavelength converter intersects with a second straight line extending a second center axis of the second wavelength converter.

In the sixth aspect, in the light source device according to the first aspect, the optical system includes: a first optical system to condense the first light having the first wavelength; and a second optical system to condense a third light having a third wavelength, the wavelength converter includes: a first wavelength converter to convert the first light to the second light; and a second wavelength converter to convert the third light to fourth light having a fourth wavelength different from the third wavelength, and a first straight line extending a first center axis of the first wavelength converter is parallel to a second straight line extending a second center axis of the second wavelength converter.

In a seventh aspect, in the light source device according to the first aspect or the second aspect, the light emitter includes: a first light emitter configured to emit first light having a first wavelength; and a second light emitter configured to emit third light having a third wavelength. The optical system includes: a first optical system to condense the first light emitted from the first light emitter at a first light condensed position; and a second optical system to condense the third light emitted from the second light emitter at a second light condensed position, the wavelength converter includes: a first wavelength converter to convert the first light to the second light; and a second wavelength converter to convert the third light to fourth light having a fourth wavelength different from the third wavelength, an optical axis passing through the first light condensed position and the second light condensed position is parallel to a line passing through a first center axis of the first wavelength converter and a second center axis of the second wavelength converter.

In an eighth aspect, a display apparatus includes: a spatial light modulator including multiple pixels and to turn on and off the light emitted from the light source device according to any one of the first aspect to the seventh aspect for each of the multiple pixels to generate an image; and a projection optical system to project the image generated by the spatial light modulator.

1. A light source device comprising:
a light emitter including a light emitting surface configured to emit first light having a first wavelength in a light emitting direction;
an optical system configured to condense the first light having the first wavelength at a light condensed position; and
a wavelength converter including a wavelength conversion region configured to convert the first light having the first wavelength to second light having a second wavelength different from the first wavelength,
wherein a center axis of the wavelength converter is parallel to the light emitting surface,
the light emitter is at a position adjacent to one end of the wavelength converter in the light emitting direction in a plane orthogonal to the center axis of the wavelength converter, and
the light condensed position of the optical system is closer to the light emitter than another end of the wavelength converter opposite to the one end in the light emitting direction in the plane.

2. The light source device according to claim 1,
wherein an edge portion of the optical system is:
closer to said another end of the wavelength converter than the light condensed position; and
closer to the light emitter than the said another end of the wavelength converter in the light emitting direction in the plane.

3. The light source device according to claim 1, further comprising a holder holding the optical system,
wherein an edge portion of the holder is:
closer to said another end of the wavelength converter than the light condensed position; and
closer to the light emitter than the said another end of the wavelength converter in the light emitting direction in the plane.

4. The light source device according to claim 1, further comprising a light combiner;
wherein the optical system includes:
a first optical system configured to condense the first light having the first wavelength at a first light condensed position; and
a second optical system configured to condense a third light having a third wavelength at a second light condensed position,
the wavelength converter includes:
a first wavelength converter configured to convert the first light to the second and
a second wavelength converter configured to convert the third light to fourth light having a fourth wavelength different from the third wavelength,
the light combiner configured to combine the first light, the second light, the third light, and the fourth light at a combining position to emit combined light,
the first light condensed position, the second light condensed position, and the combining defines a first plane,
a first center axis of the first wavelength converter and a second center axis of the second wavelength converter defines a second plane, and
the first plane is parallel to and different from the second plane.

5. The light source device according to claim 4,
wherein the optical system includes:
a first optical system configured to condense the first light having the first wavelength; and
a second optical system configured to condense a third light having a third wavelength,
the wavelength converter includes:
a first wavelength converter configured to convert the first light to the second light; and
a second wavelength converter configured to convert the third light to fourth light having a fourth wavelength different from the third wavelength, and
a first straight line extending a first center axis of the first wavelength converter intersects with a second straight line extending a second center axis of the second wavelength converter.

6. The light source device according to claim 4,
wherein the optical system includes:
a first optical system configured to condense the first light having the first wavelength; and
a second optical system configured to condense a third light having a third wavelength,
the wavelength converter includes:
a first wavelength converter configured to convert the first light to the second light; and
a second wavelength converter configured to convert the third light to fourth light having a fourth wavelength different from the third wavelength, and
a first straight line extending a first center axis of the first wavelength converter is parallel to a second straight line extending a second center axis of the second wavelength converter.

7. The light source device according to claim 1,
wherein the light emitter includes:
a first light emitter configured to emit first light having a first wavelength; and
a second light emitter configured to emit third light having a third wavelength,
wherein the optical system includes:
a first optical system configured to condense the first light emitted from the first light emitter at a first light condensed position; and
a second optical system configured to condense the third light emitted from the second light emitter at a second light condensed position,
the wavelength converter includes:
a first wavelength converter configured to convert the first light to the second light; and
a second wavelength converter configured to convert the third light to fourth light having a fourth wavelength different from the third wavelength,
an optical axis passing through the first light condensed position and the second light condensed position is parallel to a line passing through a first center axis of the first wavelength converter and a second center axis of the second wavelength converter.

8. A display apparatus comprising:
a spatial light modulator including multiple pixels and configured to turn on and off the light emitted from the light source device according to claim 1 for each of the multiple pixels to generate an image; and
a projection optical system configured to project the image generated by the spatial light modulator.
